(19) United States
(12) Patent Application Publication
(10) Pub. No.: US 2019/0121681 A1
(43) Pub. Date: Apr. 25, 2019

(54) FRAMEWORK FOR INTEGRATING A USER DEVICE AND A MAINFRAME SYSTEM

(71) Applicant: CA, INC., New York, NY (US)

(72) Inventors: DANIEL L. KELOSKY, BEAVER FALLS, PA (US); JASON ANDREW TUCKER, PITTSBURGH, PA (US); CHRISTOPHER LYNN BOEHM, PITTSBURGH, PA (US); JESSICA ANNE TONDA, CARNEGIE, PA (US)

(21) Appl. No.: 15/789,691

(22) Filed: Oct. 20, 2017

(51) Int. Cl. G06F 9/54; G06F 9/44

(52) U.S. Cl. CPC G06F 9/541; G06F 2209/544; G06F 8/315

(57) ABSTRACT

An integration framework is implemented to enable users of client side systems to integrate with and utilize mainframe systems, for example by enabling communication of commands to the mainframe and responses from the mainframe. A command is received by the integration framework via a command line interface (CLI) or in some instances an integrated development environment (IDE) on a client system. The command is converted by the integration framework to a format recognizable by an application programming interface (API) on the mainframe system. The converted command is communicated to an API on the mainframe system causing an operation corresponding to the command to be performed. A response based on the operation performed on the mainframe system is then provided back to the client system via the CLI or IDE.

### BACKGROUND

Mainframe systems can provide powerful and useful tools for many development tasks. However, legacy and remote mainframe systems do not support newer client side tools that developers and users are familiar with using. Currently there is not a way to utilize a mainframe system with a client device without having to change contexts or use “green screen” emulators. Conventionally, this becomes an issue as users must learn legacy and remote systems before being able to utilize mainframe functionality. In this regard, client-side systems and tools cannot directly utilize mainframe system resources efficiently and effectively.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards providing an integration framework to enable users of various client systems to communicate with and utilize mainframe systems. In particular, the integration framework enables users of client side systems the ability to leverage mainframe system functionality and to integrate with mainframe systems for purposes of managing and editing source code, version controls, file manipulation, configuration, and command use. For example, the integration framework can integrate version control with a remote source system through various application programming interfaces (APIs) thus integrating source management with modern integrated development frameworks (IDEs). Further, the integration framework enables the ability to issue commands to a mainframe system while providing a standardized response. This integration can be achieved by enabling terminals on the client device to interact with the remote platform.

In other embodiments of the technology described herein, an integration framework is provided to enable users of a user device to use an object-oriented programmatic interface to create mainframe job control language (JCL). In this way the integration framework can receive commands in an object-oriented format, and convert them to JCL that is recognizable by a mainframe system. Further, the integration framework can include one or more engines that convert existing JCL into a script that uses an API associated with the integration framework.

### BRIEF DESCRIPTION OF THE DRAWINGS

Aspects of the technology presented herein are described in detail below with reference to the attached drawing figures, wherein:

FIG. 1 is a diagram of an example operating environment in accordance with some aspects of the technology described herein;

FIG. 2 is a block diagram depicting an exemplary computing architecture, in accordance with some aspects of the technology described herein;

FIG. 3 is a block diagram of an exemplary computing system, in accordance with some aspects of the technology described herein;

FIG. 4 is a is a flow diagram showing a method for enabling communication between a client device and a mainframe system via an integration framework, in accordance with some aspects of the technology described herein;

FIG. 5 is a flow diagram showing a method for enabling JCL communication between a client device and a mainframe system via an integration framework, in accordance with some aspect of the technology described herein; and

FIG. 6 is a block diagram of an exemplary computing environment suitable for use in implementing embodiments of the present invention.

### DETAILED DESCRIPTION OF THE INVENTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

According to some aspects of the technology described herein, an integration framework can be provided on a client system to enable developers to carry out mainframe tasks in a way that closely matches similar functionality on the client-side tools they use without needing to switch context or have to utilize and be bound by the conventional “green screens” to carry out mainframe tasks. Initially, the integration framework package is installed on a client system and generally only requires a mainframe operating system to be configured and running and to have access to it and any application programming interfaces (APIs) of the mainframe system. Once installed, the integration framework can be configured to point to a mainframe system by initializing a global configuration. In some embodiments, configurations can be initialized in directories throughout a client device to point to other systems.

The integration framework can receive commands from a client device, convert or otherwise translate those commands into a form recognizable by the mainframe system, and direct those commands to the mainframe system in order to take advantage of mainframe functions. For example, the integration framework can receive commands via a terminal on a client device such as a command line interface or integrated terminals in an integrated development environment (IDE). The integration framework can, for instance, facilitate the development of IDE plug-ins and IDE functionality with respect to a mainframe system. It will be appreciated that collectively, the various APIs described herein, the configuration of the integration framework, and the CLIs provide the ability to integrate mainframe technology with client systems. IDEs are one exemplary way to utilize the integration framework, but there can be others as well, for example, graphical user interfaces (GUIs) or even automated systems, for example where there is no need for a user to input commands utilizing a user interface. By receiving, converting, and sending commands from the client device to a mainframe system, mainframe operations can be utilized readily on a client device. For example, in one embodiment, a CONSOLE command or TSO command can be submitted to the mainframe system directly from a terminal on a client device. A response can subsequently be received on any terminal on the client device and as such, mainframe functionality can be leveraged and integrated with development tasks on the client device. In other examples, text from a mainframe output may be isolated for use on the client device.

In some embodiments, the integration framework enables a user to manipulate mainframe datasets without the need to open a file transfer protocol (FTP) client or use interactive system productivity facility (ISPF). An entire partitioned data set (PDS) can be downloaded to a client device with one command and the integration framework can organize the results of that dataset into folders. Further, the integration framework can enable the uploading of datasets or files from a local data store or file repository or also by using the output from another command or program as an input into an upload command.

The integration framework can also create new datasets. In some embodiments, the integration framework can include a template to assist in dataset creation. In essence utilizing a template provided by the integration framework for purposes of dataset creation brings the file creation tasks for a mainframe system closer to that of a client system. For instance, dataset attributes do not have to be determined or a model dataset does not have to be used. Once a dataset is created, members from an existing dataset can be copied into the created dataset. In embodiments, according to the technology described herein, the tasks described, among others not mentioned, can be done in the same context as any other development being done on a client system.

In one example, if a user knows JCL that is required for a development task but does not know its location, the integration framework 206 can search through multiple datasets by using normalized expressions as search criteria. Member names can also be utilized to search for JCL. Further, search commands can be used to search source code on the mainframe system 204 to find elements that may be needed for a project.

Once the JCL is located, it can be submitted to the mainframe system which can in turn provide the results of a job back to the terminal on the client device. In one embodiment, the JCL can be submitted asynchronously, for example if the JCL is a long running job and a user does not want to wait for the output. In some embodiments, a user can select which specific output definitions to be viewed. In this way a user does not have to go to different screens to try and find one or more jobs, refresh them until they finish, and then select the output. In essence the integrations framework enables a user to submit jobs to the mainframe system as if they were client side processes and get the results as soon as they are available.

In embodiments of the technology, as familiar command line tools are available, the integration framework allows for the performance of advanced tasks. For example, a command can be used to download a dataset from a mainframe system, manipulate data, for example find and replace text, and upload the dataset to the mainframe system. In one example, this can be used to copy some preexisting JCL and replace the user ID or dataset prefixes. Commands utilized by the integration framework can also be nested, for example a command may be used to search for a dataset and the search results can be used as input to download the content of the dataset.

In other embodiments of the technology, a local copy of a dataset's contents can be synced with the copy of the dataset residing on the mainframe system. As datasets are easily created utilizing the integration framework, new datasets can be created on the mainframe system without having to rely on green screens or emulators. In this way, mainframe systems storing datasets or files operate similar to a remote version control repository, such as GitHub. In this way local editors can be used with remote mainframe systems.

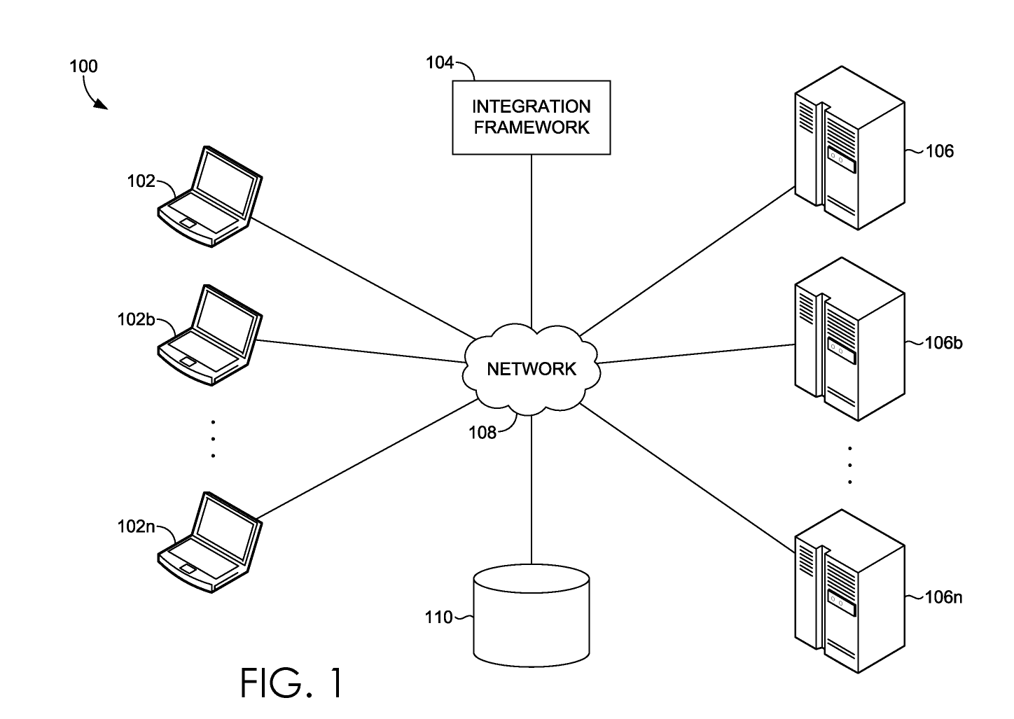

Referring now to the figures, with reference to FIG.1, FIG. 1 depicts a block diagram of an exemplary computing environment 100 in which some embodiments of the present disclosure can be employed. It should be understood that this and other arrangements described herein are set forth only as examples. Other arrangements and elements (e.g., machines, interfaces, functions, orders, and groupings of functions) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory.

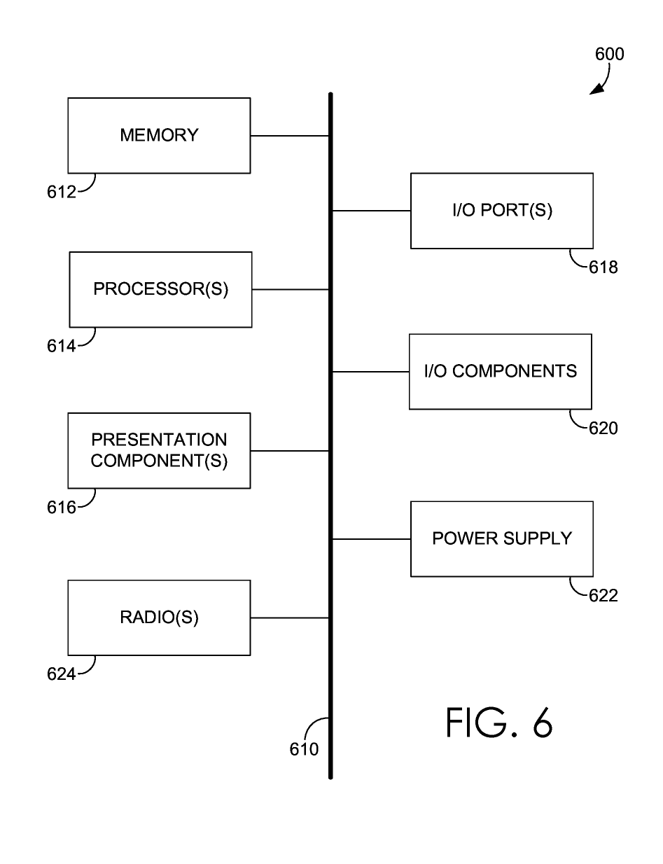

Among other components not shown, example operating environment 100 includes a workstation or user device, such as client devices 102, 102b, 102n and at least one mainframe system 106, 106b, 106n. Each of the components shown in FIG. 1 can be implemented via any type of computing device, such as computing device 600 described in connection to FIG. 6, for example. These components can communicate with each other via network 108, which can include, without limitation, one or more local area networks (LANs) and/or wide area networks (WANs). In exemplary implementations, network 130 comprises the Internet and/or a cellular network, amongst any of a variety of possible public and/or private networks.

It should be understood that any number of user devices, servers, and data sources can be employed within operating environment 100 within the scope of the present disclosure. Each can comprise a single device or multiple devices cooperating in a distributed environment. For instance, mainframe system 106 can be provided via multiple devices arranged in a distributed environment that collectively provide the functionality described herein. Additionally, other components not shown can also be included within the distributed environment.

Client devices 102, 102b, 102n can comprise any type of computing device or workstation capable of use by a user that includes a terminal. By way of example and not limitation, a client device can include a terminal as a command line interface (CLI) or a terminal as part of an integrated development environment (IDE).

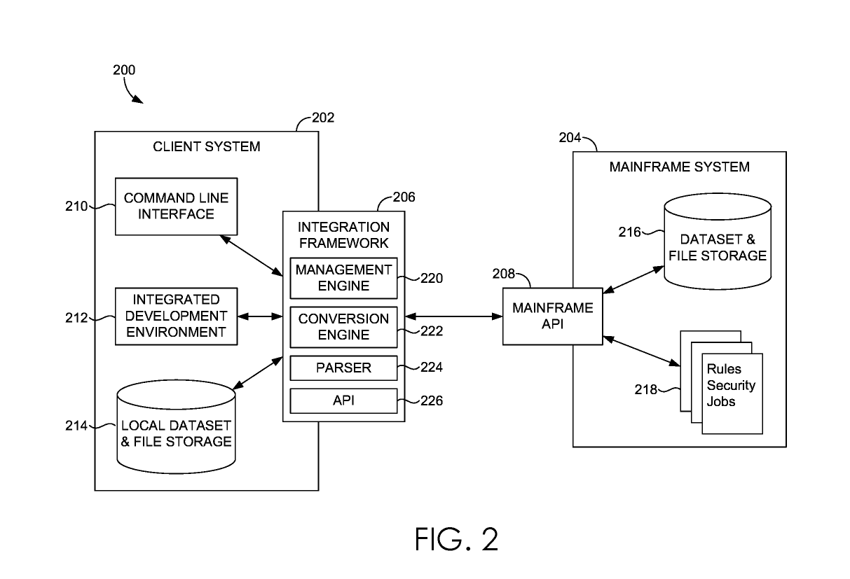

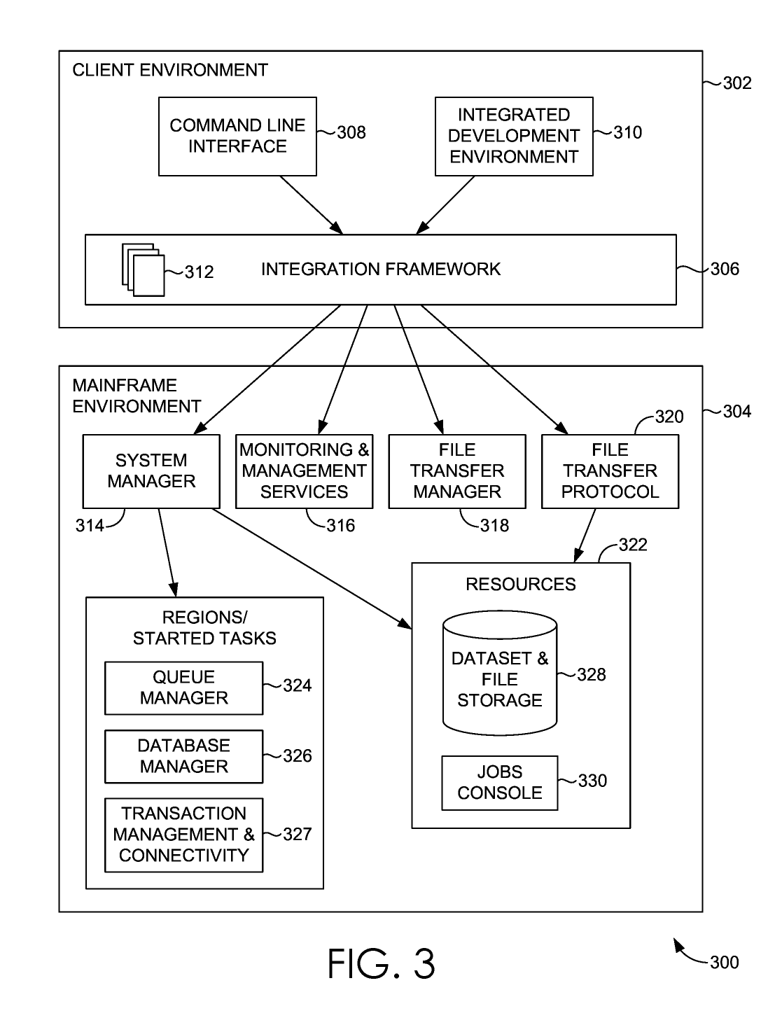

Data storage 110 can comprise data sources and/or data systems, which are configured to make data available to any of the various constituents of operating environment 100, or systems 200 and 300 described in connection to FIGS. 2 and 3. For example, in one embodiment, one or more data sources 110 can provide (or make available for access) datasets for use by any client device. Data source 110 can be discrete from client devices 102, 102b, 102n and/or mainframe systems 106, 106b, 106n or can be incorporated and/or integrated into at least one of such components. In some embodiments, each client device 102, 102b, 102n can retrieve one or more datasets from the data source 110, such that each user device 102, 102b, 102n can independently store and employ the dataset(s). In some embodiments, data source 110 can comprise a single dataset or a collection of datasets, which can be shared amongst multiple client devices. In various embodiments, the data source 110 stores a shared collection of datasets that can be interpreted, analyzed, and/or processed by the client devices 102, 102b, 102n, such that development tools running on the client device can pull, utilize, and push datasets to the data source 110.

In some embodiments, the functions of the system can be facilitated by an integration framework 104 that can be, for example, implemented on any of the client devices 102, 102b, 102n. In some instances, the integration framework 104 can enable communication between a client device 102, 102b, 102n and a remote mainframe system 106, 106b, 106n. The integration framework 104 can in some instances provide translation or conversion functionality between user systems, such as client devices 102, 102b, 102n and any number of mainframe systems106, 106b, 106n. In some exemplary embodiments, the integration framework 104 can enable functionality for purposes of managing and editing source code, dataset version control, file manipulation, configuration, and command utilization. Through various application programming interfaces (APIs) client devices and development tools contained thereon may be integrated with a remote mainframe system.

Continuing with FIG. 2, a block diagram depicting an exemplary computing architecture 200 is provided, in accordance with some aspects of the technology described herein. An integration framework 206 can be received and implemented on a client system 202. When the integration framework is running as a layer on the client system 202 it can be in operable communication with a command line interface (CLI) 210, an integrated development environment (IDE) 212, and a local storage 214. In some embodiments the local storage 214 may be implemented as data storage 110 of FIG. 1. In this way, the integration framework 206 is independent of the CLI 210 or IDE 212 on the client system 202, therefore allowing the integration framework to be utilized with any client side tools. The integration framework 206 can further be in communication with a mainframe system, such as remote mainframe system 204. Integration framework 206 can comprise, among other things, a management engine 220, conversion engine 222, a parser 224, and one or more APIs 226 or command sets. When implemented the integration framework 206 can enable or facilitate communication between the client system 202 and the mainframe system 204 through the use of any number of framework APIs 226 and any number of mainframe APIs 208.

The integration framework 206 can receive a command or multiple commands via a CLI 210 or in some instances an IDE 212 on a client device 202. The integration framework can then convert the command to a format that is recognizable by an API 208 that is on the remote mainframe system 204. The received commands can be those utilized with other tools running on the client system or may be a command that is provided to the client system by the integration framework 206. In some embodiments those commands can be in a format that is not recognizable by a mainframe system 204. Once the command has been converted to a format recognizable by the mainframe system by the integration framework 206, for example by the conversion engine 222, the command can be communicated to the mainframe API 208 on the mainframe system 204. In some embodiments, the command a CONSOLE command or a TSO command that is recognizable by the remote mainframe system 204. When the mainframe system 204 receives the command via the mainframe API 208, the mainframe API 208 can cause an operation corresponding to the command to be performed on the remote mainframe system 204. Responsive to the received command and at least in part responsive to the operation performed on the mainframe system 204, a response based on the operation performed may be sent back to the integration framework 206 and provided to the client system 202 via the CLI 210 or the IDE 212. A response from the mainframe system can, in some instances, be received asynchronously (e.g., when a large job that has not run to completion on the mainframe system has already produced a response for communication to the integration framework 206). Responses from the mainframe system 204 that are communicated back to the client system 202 via the integration framework 206 can be further utilized as an input to a second command, for example as a command nested within a second command. In some instances, a response can be parsed, for example by parser 224 of integration framework 206, programmatically from a programming language that spawns a new process and understands JavaScript Object Notation (JSON).

In some embodiments, in response to the command, a configuration file can be created on the client system 202 that includes a representation of objects that correspond to the remote mainframe system 204. In other embodiments, in response to the command, a set of credentials associated with the client system 202 may be created and utilized by the integration framework 206 to communicate with the mainframe API 208 on the remote mainframe system 204. In some embodiments, commands received by the integration framework 206 and communicated to the mainframe system 204 can enable functionality between the client system 202 and the mainframe system 204 for creating or otherwise utilizing datasets or files stored on either system. For example, in response to a command, source code on the mainframe system 204 (or stored on a Git repository) may be searched to find a specific dataset or member. In one instance, the command can cause a retrieval of a dataset or file from the remote mainframe system 204, for example a dataset or file stored in the mainframe dataset and file storage 216, or a Git repository. The retrieved dataset or file can be communicated back to the client system 202 via the integration framework 206 which can subsequently organize the dataset or file on the client system 202, for example by utilizing management engine 220. Once a dataset or file is received at the client system 202, it can be stored in local dataset and file storage 214, and a user can use local tools, for example those provided by a client side IDE, to consume or perform operations on the retrieved dataset or file. A local dataset or file that has been updated or otherwise changed can subsequently be synchronized with the mainframe system 204, or Git repository, via the integration framework 206 in response to a command received at by the client system 202, for example via the CLI 210 or IDE 212. In some embodiments, a local copy of a dataset or file may be uploaded or otherwise pushed to the mainframe system 204 via the integration framework 206 in response to a command received by the client system 202.

The integration framework 206 can be further utilized to create a dataset or file on the mainframe system 204 or a Git repository. In some embodiments, the integration framework 206 can provide one or more templates to the client system 202 to create a dataset or file, for example via the CLI 210 or the IDE 212. The integration framework 206 can further enable a user of a client system to copy members associated with an existing data set on the mainframe system 204 to the newly created dataset or file.

In one exemplary embodiment, the integration framework 206 on a client system 202 can receive job control language (JCL) corresponding to a dataset or file from remote mainframe system 204. A mainframe API 208 can be utilized to communicate the JCL to the integration framework. The integration framework 206 can then automatically parse the JCL of the dataset or file, for example utilizing parser 224. The parsed JCL of the dataset or file can subsequently converted into a format recognizable or useable by client system 202, for example via conversion engine 222. In one embodiment, the JCL of the dataset or file is converted into an object-oriented format. Further, set statements of the JCL can be converted by the integration framework 206 into variable declarations in the object-oriented format of the JCL. The converted JCL of the dataset or file can then be provided to a client device 202, for example via an editor running on the client system, by the integration framework 206. In other embodiments, variable declarations in the object-oriented format of the JCL can be utilized as an input to a command received by the integration framework 206 the client device 202, for example via an editor. When the integration framework 206 receives the variable declarations in the object-oriented format of the JCL as a command, the integration framework 206 can then convert the command to JCL and communicate that command in JCL to a mainframe API 208 causing an operation corresponding to that command to be performed on the mainframe system 204.

Turning now to FIG. 3, a block diagram of an exemplary computing system 300 for enabling communication between a client environment 302 and a mainframe environment 304, in accordance with some aspects of the technology described, herein is depicted. An integration framework 306 can be implemented in a client environment 302. The integration framework 306 can have its own resources, including, among other things, one or more APIs 312 or one or more commands that can be utilized by the client device for utilizing resources on a mainframe system 304. A command can be received by the integration framework 306 from the client device 302, for example via a CLI 308 or an IDE 310. Utilizing a command or set of commands, the integration framework 306 can enable the client device 302 to interact with mainframe environment 304, for example as a remote mainframe system. The integration framework 306 can enable interaction with one or more services running in the mainframe environment 304. For example, among other things, a system manager 314, monitoring and management services 316, a file transfer manger 318, and file transfer protocol 319. The integration framework 306 can enable interaction or communication with tasks running on the mainframe, such as a queue manager 324, a database manager 326, and transaction management and connectivity services 327, for example via the system manager 314. Additionally, the integration framework 306 can enable interaction with one or more resources 322 on the mainframe environment 304, such as datasets and files stored in dataset and file storage 328 or one or more jobs or console operations 330.

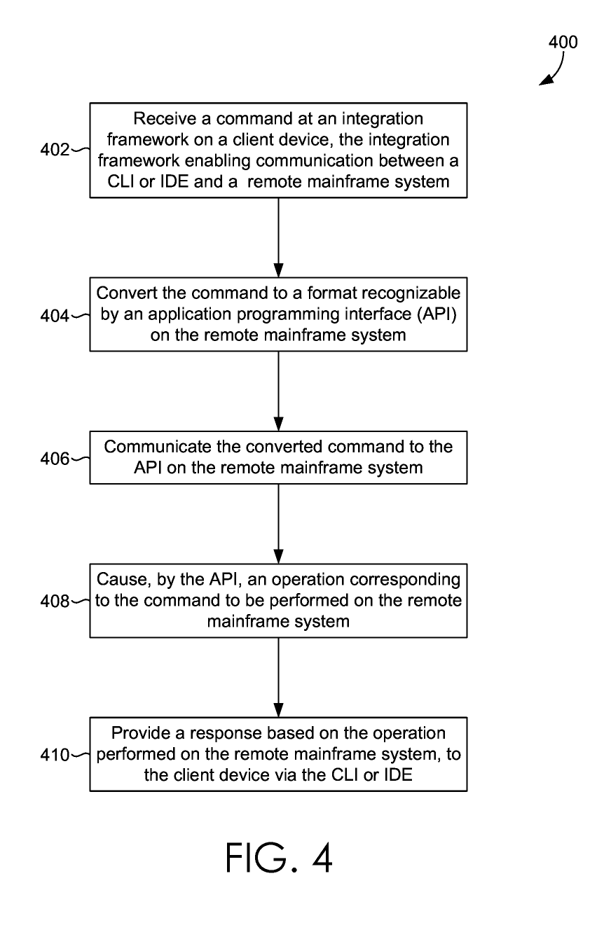

Turning now to FIG. 4, a flow diagram is provided illustrating one example method 400 for facilitating communication between a client device and a remote mainframe system. It is contemplated that each block or step of method 400 and other methods described herein comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a stand-alone application, a service or hosted service (stand-alone or in combination with another hosted service), or a plug-in to another product, to name a few.

At step 402, an integration framework running on a client device can receive a command from a client device via a CLI or IDE. The integration framework enables and facilitates communication between the CLI or IDE and a remote mainframe system. The received command may be in some instances in a format that is not recognizable or usable by the remote mainframe system. At step 404, the command is converted to a format that is recognizable by an API on the remote mainframe system. In one embodiment, a command received in an object-oriented format can be converted to job control language (JCL). At step 406, the converted command is communicated to the API on the remote mainframe system. Once the command is received by an API on the remote mainframe system, at step 408 the API can cause an operation corresponding to the command to be performed on the remote mainframe system. Based on the operation performed on the remote mainframe system, at step 410 the remote mainframe system may provide a response based on the performed operation to the integration framework which is subsequently communicated to the client device via the CLI or IDE.

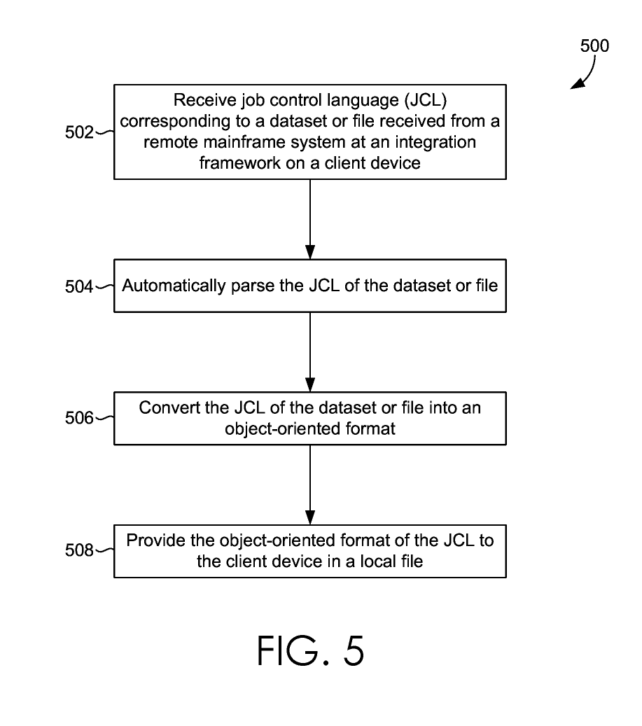

Turning now to FIG. 5, a flow diagram is provided illustrating one example method 500 for facilitating communication between a client device and a remote mainframe system via an integration framework. At step 502, an integration framework on a client device can receive job control language (JCL) corresponding to a dataset or file from a remote mainframe system. At step 504, the integration framework can automatically parse the JCL of the dataset or file, for example by parser 224 of FIG. 2. At step 506, the integration framework can convert the parsed JCL of the dataset or file into an object-oriented format, for example by conversion engine 222 of FIG. 2. Subsequently, at step 508, the integration framework can provide or otherwise communicate the object-oriented format of the JCL to the client device in a local file, for example a local PC file. A user can utilize an editor to view the results of the object-oriented format of the JCL.

Having described various embodiments of the invention, an exemplary computing environment suitable for implementing embodiments of the invention is now described. With reference to FIG. 6, an exemplary computing device is provided and referred to generally as computing device 600. The computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention can be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention can be practiced in a variety of system configurations, including handheld devices, consumer electronics, general-purpose computers, more specialty computing devices. Embodiments of the invention can also be practiced in distributed computing environments where tasks are performed by remote-processing devices that are linked through a communications network. In a distributed computing environment, program modules can be located in both local and remote computer storage media including memory storage devices.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what can be one or more buses (such as an address bus, data bus, or combination thereof). Although the various blocks of FIG. 6 are shown with lines for the sake of clarity, in reality, these blocks represent logical, not necessarily actual, components. For example, one can consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more embodiments of the present invention. Distinction is not made between such categories as “workstation,” “server,” “laptop,” “client device/system,” “user device,” “computing device,” or “mainframe system,” as all are contemplated within the scope of FIG. 6.

Computing device 600 typically includes a variety of computer-readable media. Computer-readable media can be any available media that can be accessed by computing device 600 and includes both volatile and nonvolatile, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory can be removable, non-removable, or a combination thereof. Exemplary hardware devices include solid-state memory, hard drives, optical-disc drives. Computing device 700 includes one or more processors 614 that read data from various entities such as memory 612 or I/O components 620. Presentation component(s) 616 presents data indications to a user or other device. Exemplary presentation components include a display device, speaker, printing component, vibrating component, and the like.

The I/O ports 618 allow computing device 600 to be logically coupled to other devices, including I/O components 620, some of which can be built in. Illustrative components include a microphone, joystick, game pad, satellite dish, scanner, printer, wireless device. Some embodiments of computing device 600 can include one or more radio(s) 624 (or similar wireless communication components). The radio 624 transmits and receives radio or wireless communications. The computing device 600 can be a wireless terminal adapted to receive communications and media over various wireless networks. Computing device 600 can communicate via wireless protocols, such as code division multiple access (“CDMA”), global system for mobiles (“GSM”), or time division multiple access (“TDMA”), as well as others, to communicate with other devices. The radio communications can be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection can include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection can include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and can be employed without reference to other features and sub-combinations and are contemplated within the scope of the claims.

What is claimed is:

1. A method comprising:
receiving a command, provided via a command line interface (CLI) or an integrated development environment (IDE) on a client device, at an integration framework on the client device, the integration framework enabling communication between the CLI or IDE and a remote mainframe system;
converting the command, at the integration framework, from a syntax not recognizable by an application programming interface (API) on the remote mainframe system to a syntax recognizable by the API on the remote mainframe system;
communicating the command, in the converted syntax, to the API on the remote mainframe system, the API causing an operation corresponding to the command to be performed on the remote mainframe system; and
providing, by the integration framework, a response based on the operation performed on the remote mainframe system, to the client device via the CLI or IDE.

2. The method of claim 1, further comprising, in response to the command, creating a configuration file on the client device that includes a representation of objects corresponding to the remote mainframe system.

3. The method of claim 1, further comprising, in response to the command, creating a set of credentials associated with the client device that is used by the integration framework to communicate with the API on the remote mainframe system.

4. The method of claim 1, wherein the integration framework is independent of the CLI or IDE on the client device.

5. The method of claim 1, wherein the command is one of a CONSOLE command and a TSO command.

6. The method of claim 1, further comprising, in response to the command, retrieving a dataset or file from the remote mainframe system.

7. The method of claim 6, further comprising organizing, by the integration framework, the dataset or file on the client device.

8. The method of claim 7, further comprising, in response to the command, synchronizing, by the integration framework layer, the dataset or file on the client device with the dataset or file on the remote mainframe system.

9. The method of claim 6, further comprising, in response to the command, uploading a local copy of the dataset or file to the remote mainframe system.

10. The method of claim 1, further comprising utilizing a template provided by the integration framework to cause a dataset or file to be created on the remote mainframe system.

11. The method of claim 10, further comprising, in response to the command, copying members of an existing dataset or file into the dataset or file.

12. The method of claim 1, further comprising, in response to the command, searching source code on the remote mainframe system for a dataset or member.

13. The method of claim 1, wherein the response is received from the remote mainframe system asynchronously.

14. The method of claim 1, further comprising utilizing the response based on the operation performed on the remote mainframe system as an input to a second command, the command being nested within the second command.

15. The method of claim 1, wherein the response is parsed programmatically from a programming language that spawns a new process and understands JavaScript Object Notation.

16. A method comprising:
receiving, at an integration framework on a client device, job control language (JCL) corresponding to a dataset or file received from a remote mainframe system;
automatically, at the integration framework, parsing the JCL of the dataset or file;
converting, at the integration framework, the JCL of the dataset or file into an object-oriented format; and
providing, by at the integration framework, the object-oriented format of the JCL to the client device via an editor.

17. The method of claim 16 further comprising converting, by the integration framework, set statements of the JCL into variable declarations in the object-oriented format of the JCL.

18. The method of claim 17, further comprising enabling the variable declarations to be utilized as an input to a command received by the integration framework from the client device via the editor.

19. The method of claim 18, further comprising:
converting the command, at the integration framework, to JCL; and
communicating the command, in JCL, to an application programming interface (API) on the remote mainframe system, the API causing an operation corresponding to the command to be performed on the remote mainframe system.

20. A computerized system comprising:
a processor; and
a computer storage medium storing computer-useable instructions that, when used by the processor, cause the processor to:
receive a command, via a command line interface (CLI) or an integrated development environment (IDE) on a client device, at an integration framework on the client device, the integration framework enabling the command to be communicated to a remote mainframe system;
convert the command, at the integration framework, to a syntax recognizable by an application programming interface (API) on the remote mainframe system;
communicate the command, in the converted syntax, to the API on the remote mainframe system, the API causing an operation corresponding to the command to be performed on the remote mainframe system; and
provide, by the integration framework, a response based on the operation performed on the remote mainframe system, to the client device via the CLI or IDE.
